(19) United States
(12) Patent Application Publication
(10) Pub. No.: US 2002/0024680 A1
(43) Pub. Date: Feb. 28, 2002

(54) Method of an apparatus for processing color image, and recording medium storing therein program for carrying out the method

(76) Inventor: Michael Mehigan, Inashiki-gun (JP)

Correspondence Address: NIXON PEABODY, LLP, 8180 GREENSBORO DRIVE, SUITE 800, MCLEAN, VA, 22102, US

(21) Appl. No.: 09/938,492

(22) Filed: Aug. 27, 2001

(30) Foreign Application Priority Data
Aug. 30, 2000 (JP) 2000-261159

(51) Int. Cl. B41J 1/00; G06K 1/00; B41B 1/00; G06F 15/00; G06K 9/00

(52) U.S. Cl. 358/1.9; 382/162

(57) ABSTRACT

When a halftone color image is to be printed in monochrome, the halftone color image is processed. Line-like parts of the halftone color image are processed by a clustered dot dithering technique or a dispersed dot dithering technique according to a predetermined property of the line-like parts.

### BACKGROUND OF THE INVENTION

1. Field of the Invention

This invention relates to a method of and an apparatus for processing a halftone color image when the halftone color image is to be printed in monochrome, and more particularly to a method of and an apparatus for processing a line-like part of the color image. This invention also relates to a recording medium which stores therein a program for carrying out the method.

2. Description of the Related Art

Recently almost all the digital images are color images having a halftone part owing to advance in image processing, reduction in price of data storage devices such as memories and hard disks, and the like. Though color printers are being popularized, halftone color images are often output through a monochromatic printer. Further color images are sometimes output through a monochromatic printer for a special effect. When image data representing a halftone color image, for instance, from a computer is input into the monochromatic printer, it is necessary to carry out image processing on the color image data and to obtain binary-coded image data for printing in order to obtain high quality prints.

The binary coding is processing for dividing pixels into white pixels (ink is not supplied) and black pixels (ink is supplied). As the method of binary-coding color image data, the clustered dot dithering technique and the dispersed dot dithering technique are well known. In order to improve finish of the print in a low resolution monochromatic printer (including color printers operating in a monochromatic printing mode) not higher than 600 dpi, the clustered dot dithering technique is preferred to the dispersed dot dithering technique since when the dispersed dot dithering technique is applied to such a low resolution printer, especially a low resolution printer whose dot gain is relatively large, the print is apt to be darkened.

In order to simplify the calculation involved in the binary coding of color image data, a plurality of brush patterns different from each other by density are prepared in advance for different processing methods (e.g., whether the processing is the clustered dot dithering technique or the dispersed dot dithering technique) and image processing is carried out on parts such as lines and characters which are simple in color pattern by the use of one of the brush patterns selected according to the processing method and the density of the part.

As described above, in a low resolution monochromatic printer not higher than 600 dpi, the clustered dot dithering technique is preferred to the dispersed dot dithering technique from the viewpoint of finish of the print. However there is a problem that when the clustered dot dithering technique is carried out on a line-like part of a color image, e.g., a line itself and a line-like part of a character, the clustered dot dithering technique can sometimes produce a broke or faded line especially when the line-like part is thin and high in density and the printer is of low resolution and a large dot gain. Depending on the condition, the clustered dot dithering technique may even fail to print a line.

For example, when a part A of a relatively thick line shown in FIG. 1A is subjected to the clustered dot dithering with a clustered dot brush pattern B shown in FIG. 1B (selected according to the density of the part A), dithered image data C is obtained as shown in FIG. 1C. In this case, the dithered image data C represents the dithered image of the part A. To the contrast, when a part A1 of a relatively thin line shown in FIG. 2A is subjected to the clustered dot dithering with a clustered dot brush pattern B1 shown in FIG. 2B (selected according to the density of the part A1), dithered image data C1 is obtained as shown in FIG. 2C. In this case, the dithered image data C1 represents no image.

### SUMMARY OF THE INVENTION

In view of the foregoing observations and description, the primary object of the present invention is to provide a method of and an apparatus for processing a halftone color image when the halftone color image is printed in monochrome which can produce a high quality print and at the same time can prevent a thin line from being broken or eliminated.

Another object of the present invention is to provide a recording medium which stores therein a program for carrying out the method.

In accordance with a first aspect of the present invention, there is provided a method of processing a halftone color image when the halftone color image is to be printed in monochrome, the method characterized by the steps of

detecting a predetermined property of a line-like part of the halftone color image, and

processing the line-like part of the halftone color image by a clustered dot dithering technique or a dispersed dot dithering technique according to the predetermined property of the line-like part.

That is, in the method of the present invention, when a halftone color image is to be printed in monochrome by a printer, especially those whose resolution is not higher than 600 dpi, line-like parts of the color image is selectively processed by a clustered dot dithering technique or a dispersed dot dithering technique according to the predetermined property of the part. When the color image is processed entirely by the dispersed dot dithering technique, finish of prints becomes low and when color image is processed entirely by the clustered dot dithering technique, line-like parts which are thin and low in density are sometimes further thinned or lost. By processing line-like parts of the color image selectively by the clustered dot dithering technique or the dispersed dot dithering technique according to the property of the parts, the aforesaid drawbacks inherent to the respective techniques can be avoided.

The “printer” may be any printing device provided that it can be connected to a personal computer or the like through a printer terminal, a network terminal or the like and can produce copies of an image sent from the personal computer or the like without limited to those which are generally referred to as “printers”, e.g., a laser printer, an ink jet printer and the like. For example, a stencil printer which makes a stencil on the basis of image data sent from a personal computer and makes prints on the basis of the stencil may be included in a “printer”, as used here.

The printer need not be inherently a monochromatic printer but may be a color printer so long as the color image can be printed in monochrome by the printer.

Further, the term “line-like part” includes not only a line but also a line-like part of a character or the like.

The predetermined property may be any property so long as the image processing method selected on the basis of the property can produce a good result. For example, the predetermined property may be the thickness and density of the line-like part. However, in order to prevent a thin line from being broken or eliminated and at the same time to simplify the calculation involved in the binary coding of color image data, it is preferred that the predetermined property be the thickness of the line-like part only so that when the line-like part is of a thickness larger than a threshold value, the part is processed by the clustered dot dithering technique and when the part is of a thickness not larger than the threshold value, the part is processed by the dispersed dot dithering technique. In this case, it is preferred that the threshold value is a value corresponding to 4 dots.

Since it is preferred that the color image be processed by the clustered dot dithering technique over the widest possible area in order to improve finish of the prints and the clustered dot dithering technique eliminates line-like parts mainly when the parts are thin and of a high density, it is preferred that the predetermined property includes both the thickness and the density of the line-like parts so that when the line-like part is of a thickness smaller than a first threshold value and at the same time of a density higher than a second threshold value, the part is processed by the dispersed dot dithering technique and otherwise the part is processed by the clustered dot dithering technique.

In this case, it is preferred that the first threshold value be a value corresponds to 4 dots and the second threshold value be a value corresponding to 220 if the density of the image data ranges from 0 (white) to 255 (black).

As data on the thickness and the density of the line-like part, attribute data on the thickness and the density of individual graphic forms and/or characters contained in color image data received from the image software may be employed as it is.

It is preferred that the method of the present invention be carried out by a printer driver since the printer driver is in one-to-one correspondence with the printer and accordingly, it is easy to carry out fine adjustments.

Further, in order to simplify the calculation and increase the processing speed, it is preferred that series of brush patterns be respectively prepared in advance for the clustered dot dithering and the dispersed dot dithering. The brush patterns are prepared according to the density of the line-like part.

In accordance with a second aspect of the present invention, there is provided an apparatus for processing a halftone color image when the halftone color image is to be printed in monochrome, the apparatus characterized by

a selecting means which selects a clustered dot dithering technique or a dispersed dot dithering technique according to a predetermined property of a line-like part of the halftone color image, and

a processing means which processes the line-like part of the halftone color image by the method selected by the selecting means.

In accordance with a third aspect of the present invention, there is provided a recording medium in which a program for carrying out the method of the first aspect of the present invention is recorded.

When the recording medium of the third aspect of the present invention is installed in a computer, the computer comes to function as an image processing apparatus of the present invention.

### BRIEF DESCRIPTION OF THE DRAWINGS

FIG. 1A shows an example of a halftone color image including a thick line-like part,

FIG. 1B shows an example of the brush pattern employed in processing a part of the thick line-like part shown in FIG. 1A by the clustered dot dithering technique,

FIG. 1C shows a dithered image of the part of the line-like part obtained by carrying out the clustered dot dithering on the part of the halftone color image shown in FIG. 1A,

FIG. 2A shows an example of a halftone color image including a thin line-like part,

FIG. 2B shows an example of the brush pattern employed in processing a part of the thin line-like part shown in FIG. 2A by the clustered dot dithering technique,

FIG. 2C shows a dithered image of the part of the line-like part obtained by carrying out the clustered dot dithering on the part of the halftone color image shown in FIG. 2A,

FIG. 3A shows an example of a halftone color image including a thin line-like part,

FIG. 3B shows an example of the brush pattern employed in processing a part of the thin line-like part shown in FIG. 3A by the dispersed dot dithering technique,

FIG. 3C shows a dithered image of the part of the line-like part obtained by carrying out the dispersed dot dithering technique on the part of the halftone color image shown in FIG. 3A,

FIG. 4 is a flow chart for illustrating the procedure of image processing in accordance with a first embodiment of the present invention, and

FIG. 5 is a flow chart for illustrating the procedure of image processing in accordance with a second embodiment of the present invention.

### DESCRIPTION OF THE PREFERRED EMBODIMENTS

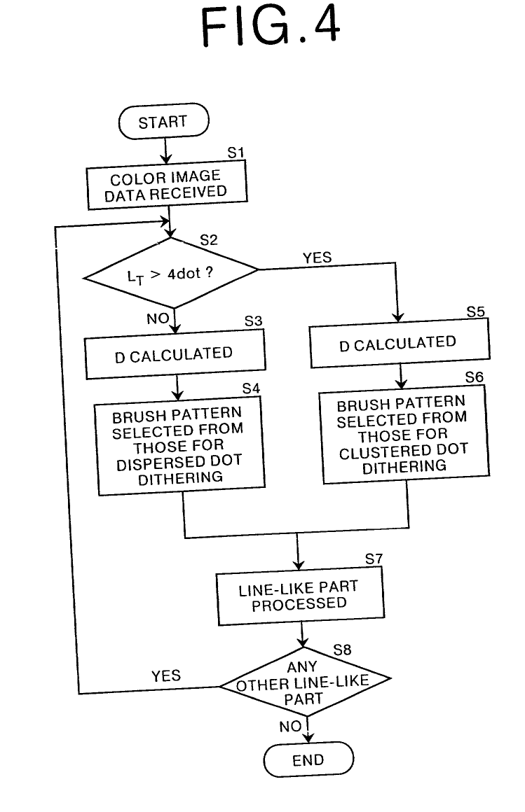

FIG. 4 is a flow chart for illustrating operation of a printer driver which carries out an image processing method in accordance with a first embodiment of the present invention. The printer driver is installed in a computer. The printer driver receives color image data from graphic software in the computer and binary-codes the color image data to obtain image data conforming to output of a monochromatic printer, whose resolution is not higher than 600 dpi in this particular embodiment. FIG. 4 only shows the image processing to be carried out on line-like parts of the color image but it is preferred that the other parts of the color image be processed by the clustered dot dithering technique.

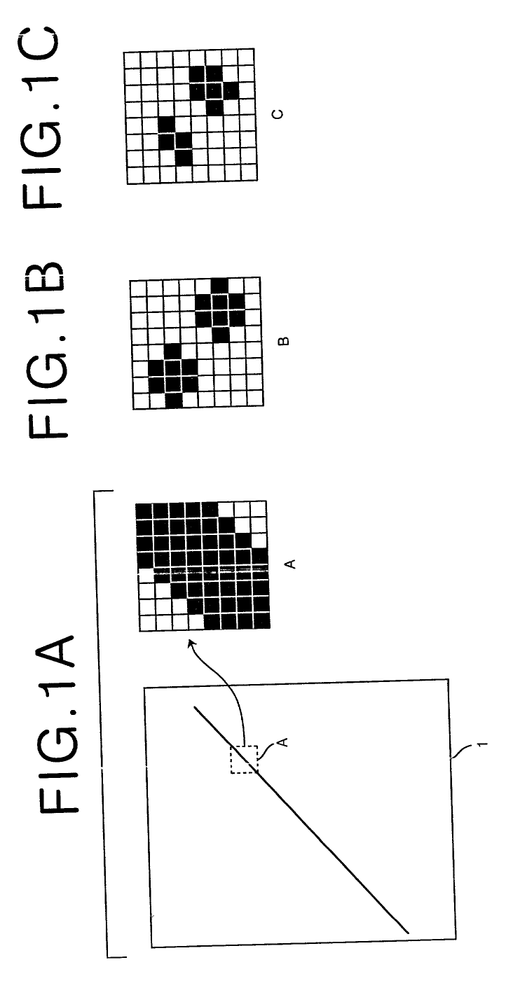

As shown in FIG. 4, the printer driver first receives color image data from the graphic software (step SI) and, when a line-like part exists in the color image, the printer driver determines whether the thickness L_{T} of the line-like part is larger than the thickness corresponding to 4 dots (step S2). When it is determined that the thickness L_{T} of the line-like part is larger than the thickness corresponding to 4 dots, the printer driver processes the line-like part of the color image by a clustered dot dithering technique. That is, the printer driver selects one of brush patterns for the clustered dot dithering technique, which have been prepared for different densities, on the basis of the density D of the line-like part (steps S5 and S6). Then the printer driver processes the line-like part of the color image by the clustered dot dithering technique with the selected brush pattern in the manner shown in FIGS. 1A to 1C (step S7).

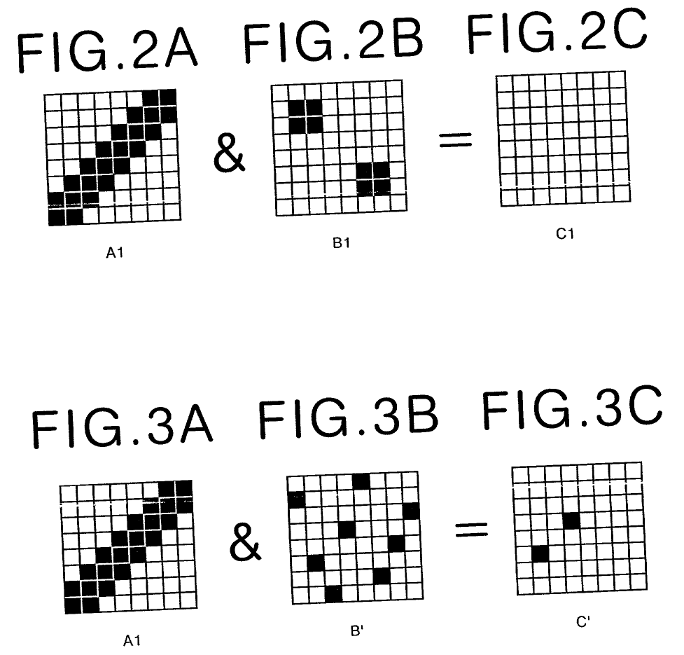

To the contrast, when it is determined in S2 that the thickness L_{T} of the line-like part is not larger than the thickness corresponding to 4 dots, the printer driver processes the line-like part of the color image by a dispersed dot dithering technique. That is, the printer driver selects one of brush patterns for the dispersed dot dithering technique, which have been prepared for different densities, on the basis of the density D of the line-like part (steps S3 and S4). Then the printer driver processes the line-like part of the color image by the dispersed dot dithering technique with the selected brush pattern B′ in the manner shown in FIGS. 3A to 3C (step S7). As described above in conjunction with FIGS. 2A to 2C, when a line-like part thinner than the thickness corresponding to 4 dots is processed by the clustered dot dithering technique with a brush pattern B1 selected from brush patterns for clustered dot dithering technique according to the density of the line-like part, the line-like part can be lost or broken.

Steps S2 to S7 are repeated for all the line-like parts in the color image.

In this embodiment, since only the parts which can be lost or broken when processed by the clustered dot dithering technique are processed by the dispersed dot dithering technique and the other parts are processed by the clustered dot dithering technique, deterioration in quality of prints reproduced on the basis of the dithered image data can be minimized while the thin line-like parts can be prevented from being lost or broken. Further, since the clustered dot dithering technique or the dispersed dot dithering technique is selected on the basis of only the thickness of the line-like parts, the calculation involved in the binary coding of the color image data is simple and accordingly, the image processing can be carried out in a short time.

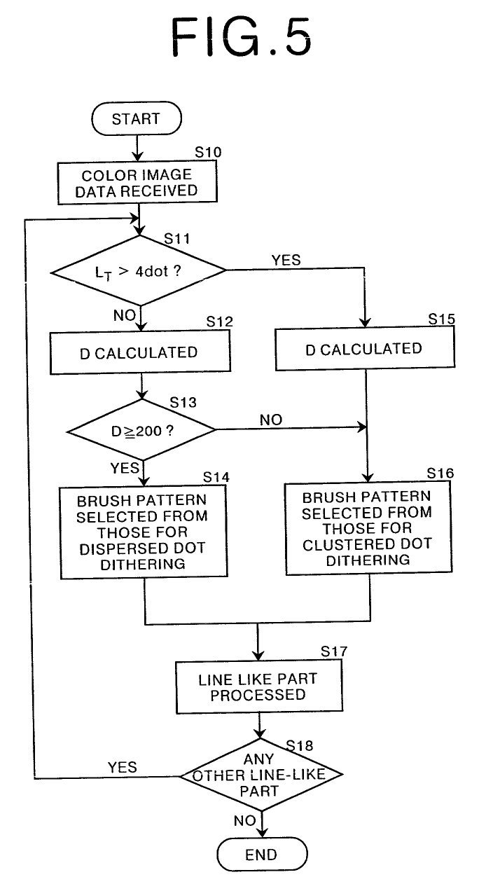

FIG. 5 is a flow chart for illustrating operation of a printer driver which carries out an image processing method in accordance with a second embodiment of the present invention. FIG. 5 only shows the image processing to be carried out on line-like parts of the color image.

As shown in FIG. 5, the printer driver first receives color image data from the graphic software (step S10) and, when a line-like part exists in the color image, the printer driver determines whether the thickness L_{T} of the line-like part is larger than the thickness corresponding to 4 dots (step S1). When it is determined that the thickness L_{T} of the line-like part is larger than the thickness corresponding to 4 dots, the printer driver processes the line-like part of the color image by a clustered dot dithering technique. That is, the printer driver selects one of brush patterns for the clustered dot dithering technique, which have been prepared for different densities, on the basis of the density D of the line-like part (steps S15 and S16). Then the printer driver processes the line-like part of the color image by the clustered dot dithering technique with the selected brush pattern (step S17).

To the contrast, when it is determined in S11 that the thickness L_{T} of the line-like part is not larger than the thickness corresponding to 4 dots, the printer driver determines whether the density of the line-like part is not lower than 200 (step S13). When it is determined that the density of the line-like part is lower than 200, the printer driver selects one of brush patterns for the clustered dot dithering technique and processes the line-like part of the color image by the clustered dot dithering technique with the selected brush pattern (steps S16 and S17). When it is determined that the density of the line-like part is not lower than 200, the printer driver processes the line-like part of the color image by a dispersed dot dithering technique. That is, the printer driver selects one of brush patterns for the dispersed dot dithering technique on the basis of the density D of the line-like part (step S14). Then the printer driver processes the line-like part of the color image by the dispersed dot dithering technique with the selected brush pattern (step S17).

Steps S11 to S17 are repeated for all the line-like parts in the color image.

In this embodiment, since only the parts which are larger than 4 dots in thickness and not smaller than 200 in density are processed by the dispersed dot dithering technique and the other parts are processed by the clustered dot dithering technique, deterioration in quality of prints reproduced on the basis of the dithered image data can be further minimized while the thin line-like parts can be prevented from being lost or broken.

The present invention need not be limited to the illustrated embodiments described above but may be variously modified.

For example, though, in the embodiments described above, the line-like parts of the color image are processed by the use of brush patterns, such brush patterns need not be employed.

Further, the threshold values for the thickness and density of the line-like parts need not be 4 dots and 200 and may be changed according to the performance and the like of the printer.

What is claimed is:

1. A method of processing a halftone color image when the halftone color image is to be printed in monochrome, the method characterized by the steps of
detecting a predetermined property of a line-like part of the halftone color image, and
processing the line-like part of the halftone color image by a clustered dot dithering technique or a dispersed dot dithering technique according to the predetermined property of the line-like part.

2. A method as defined in claim 1 in which the halftone color image is printed in monochrome by a printer which is not higher than 600 dpi in resolution.

3. A method as defined in claim 2 in which the predetermined property is the thickness of the line-like part so that when the line-like part is of a thickness larger than a threshold value, the part is processed by the clustered dot dithering technique and when the part is of a thickness not larger than the threshold value, the part is processed by the dispersed dot dithering technique.

4. A method as defined in claim 3 in which the threshold value is a value corresponding to 4 dots.

5. A method as defined in claim 2 in which the predetermined property includes both the thickness and the density of the line-like parts so that when the line-like part is of a thickness smaller than a first threshold value and at the same time of a density higher than a second threshold value, the part is processed by the dispersed dot dithering technique and otherwise the part is processed by the clustered dot dithering technique.

6. A method as defined in claim 2 characterized by being carried out by a printer driver.

7. A method as defined in claim 2 in which two series of brush patterns are respectively prepared in advance for the clustered dot dithering technique and the dispersed dot dithering technique, each series of brush patterns being prepared according to the density of the line-like part, and the clustered dot dithering technique and the dispersed dot dithering technique are carried out by the use of the brush patterns selected according to the density of the line-like part.

8. An apparatus for processing a halftone color image when the halftone color image is to be printed in monochrome, the apparatus characterized by
a selecting means which selects a clustered dot dithering technique or a dispersed dot dithering technique according to a predetermined property of a line-like part of the halftone color image, and
a processing means which processes the line-like part of the halftone color image by the method selected by the selecting means.

9. An apparatus as defined in claim 8 in which the halftone color image is printed in monochrome by a printer which is not higher than 600 dpi in resolution.

10. A recording medium in which a program for carrying out the method defined in claim 1 is recorded.

11. A recording medium as defined in claim 10 in which the halftone color image is printed in monochrome by a printer which is not higher than 600 dpi in resolution.
